(19) United States
(12) Patent Application Publication
(10) Pub. No.: US 2011/0225005 A1
(43) Pub. Date: Sep. 15, 2011

(54) PHYSICIAN AND MEDICAL VENDER APPOINTMENT AND DONATION METHOD

(76) Inventor: Parran Foster, Waldorf, MD (US)

(21) Appl. No.: 13/113,895

(22) Filed: May 23, 2011

Related U.S. Application Data
(63) Continuation of application No. 12/187,350, filed on Aug. 6, 2008.

(51) Int. Cl. G06Q 10/00; G06Q 50/00

(52) U.S. Cl. 705/2

(57) ABSTRACT

A system and method of providing access to physicians by medical venders and making donations is disclosed. At least one vender and at least one physician registers with a database for scheduling appointments between them. The physician enters a calendar of available time segments into the database and the vender purchases at least one time segment by paying a fee, said time segment corresponding to an appointment of a specified time with the physician. If the appointment is kept by both the physician and the vender, at least some portion of the fee becomes proceeds that are donated to an educational or charitable organization of the physician's choosing. If the appointment is not kept, the fee may either be returned to the vendor or at least some portion of the fee become proceeds that are donated to an educational or charitable organization of the physician's choosing, depending on pre-established protocol.

### CROSS-REFERENCE TO RELATED APPPLICATION

This application is a Continuation Application and claims the priority filing date of application Ser. No. 12/187,350 filed on Aug. 6, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

As rising healthcare costs place time constraints on physicians, medical venders frequently make personal calls to physician offices to introduce new information about products or services. These visits are necessary to keep physicians informed of new medical developments; however, no effective system currently exists to organize and manage these visits, resulting in wasted time since venders miss appointments, visit randomly, and due to redundant visits by multiple venders. Therefore, there is a need for a system that efficiently and accurately organizes marketing visits to physician offices, and which also compensates physicians for their time. The compensation comes in the form of proceeds that are donated to an educational or chariable organization of the physician's choosing.

U.S. Pat. No. 6,961,418 to Thygeson, et al discloses a system wherein appointments for a professional are captured and placed on an “electronic” waiting list (e.g., database of scheduled appointments) in an appointment system. When available, the professional (e.g., physician) communicates with the appointment system and announces his availability. The appointment system begins contacting individuals (e.g., patients) on the waiting list (e.g., in an order specified by the professional), and then bridges the physician and patient for the appointment. The communications are preferably telephone calls, but may be telephone, electronic chats, e-mail, pages, etc. The appointment system includes a billing interface that charges the patient/patients insurance for the appointment. The Appointments themselves may be scheduled, for example, via a touch tone phone response system, a web interface, or other communication devices, etc.

Although Thygeson discloses a system for managing appointments, it does not take into account doctor visits by non-patients and venders of medical products and services in particular. Furthermore, the instant invention does not require individual contact by the system nor does it maintain a waiting list for appointments. Instead, the present system allows venders to select and pay for available appointment times; in addition to using protocols for preventing missed appointments, redundant visits, and situations wherein products are marketed to physicians outside their field of expertise.

It is therefore an object of the present invention to provide an improved system of organizing and scheduling meetings between physicians and venders of medical products and services. A further object of the present invention is to provide a single point of contact wherein a physician's calendar availability is posted and venders can buy available time segments purchased by the system from physicians who then direct the proceeds to an educational or charitable orgaization. A further object of the present invention is to provide protocols in the system, whereby protocols are set up to regulate payments and payment forfeitures according to whether appointments are kept or missed.

### SUMMARY

An improved system and method of providing access to physicians by medical venders is herein disclosed comprising a system of organizing access to physicians, by requiring medical venders to purchase time slots from a physician's availability calendar, and which proceeds are donated to an educational or charitable organization of a physician's choosing. Physicians enroll in the system free of charge, and provide a schedule of 5 minute time segments determined from their personal office calendars to meet with medical venders to discuss medical products and services, wherein venders pay for the meetings online.

The system further comprises a database providing a single point of contact where physician calendars are maintained and displayed, and allowing venders to make and pay for new appointments. The database regulates appointments according to a protocol governing the length and frequency of appointments, tracks fee forfeitures and allocates refunds into an online bank based on established appointment rules.

Physicians and vendors enroll in the system, an Internet based website. Physicians create a secure user ID, and provide information related to their specialties and contact information. Venders also create a secure user ID, and provide information regarding corporate affiliation and contact information. Vendors may pay an initial fee for enrollment in the system.

Enrolled physicians consult their private office calendars, and select times they will be available for appointments with venders. Once these times are identified, they may input this information into the system, which will maintain a calendar of availability for all participating physicians and venders. Venders may consult the identities and specializations of physicians who may be interested in the goods and services offered by a vender. The system posts physician availability, including a search feature that allows vendors to seek out physicians according to search parameters. Venders may consult the identities and specializations of physicians who may be interested in the goods and services offered by a vender. Time periods already selected for appointments may be blocked off and are invisible so that only available appointments are shown.

When a time segment is selected, the vendor is prompted to pay for the appointment at that time. Protocols are set up that govern the duration, frequency and timing of appointments, including appointments comprising five minute time periods, consecutive appointment frequency, and a protocol allowing vender representatives to cancel appointments up to a predetermined time prior to the appointment for a refund, after which the appointment fee is forfeited, including forty eight hours prior to an appointment, an additional protocol governing the grace period beyond which appointment fees will be forfeited, including a five minute grace period, and a protocol governing circumstances wherein the physician is unable to keep an appointment and therefore cannot donate proceeds to an educational or charitable organization. Fees that are returned due to a physician's inability to meet with a vendor are banked and maintained in the vendor's account within the system. Proceeds earned for successful meetings by a physican during the previous month are paid by check to an educational or charitable organization of the physician's choosing within the first 20 days of the succeeding month.

When appointments are missed by a vender or physician, the appointment fee will either be donated to an educational or charitable organization of the physician's choosing or be refunded to the vendor, including reimbursement to a vender account.

### FIGURES

FIG. 1 is a diagram of the method of the present invention, showing the steps involved in executing the system.

### DESCRIPTION

An improved system and method of providing access to physicians by medical venders is herein disclosed and described. The method comprises a system of regulating access to physicians, and donating proceeds to an educational or charitable organization of the physician's choosing that permits physicians to enroll in the system free of charge, and make themselves available, according to their individual office calendars, to meet with medical venders for the purposes of discussing venders' products and services, wherein the venders purchase time segments set aside for the meetings and the proceeds are donated to the educational or charitable organization. The types of meetings anticipated by the system include in-person office visits by venders for the purpose of marketing their products or services via formal presentations; therefore, vender representatives delivering samples, and representatives responding to physician requests for visits are outside the scope of the system.

The system further comprises a coordinated database that allows physicians and venders to enroll in the system, the database comprising a single point of contact wherein individual physician calendars and appointment availability are maintained, with the capability of allowing venders to make and pay for new appointments, and regulate appointments according to a protocol governing the length and frequency of appointments, and allocating fee forfeitures and refunds based on established program policies.

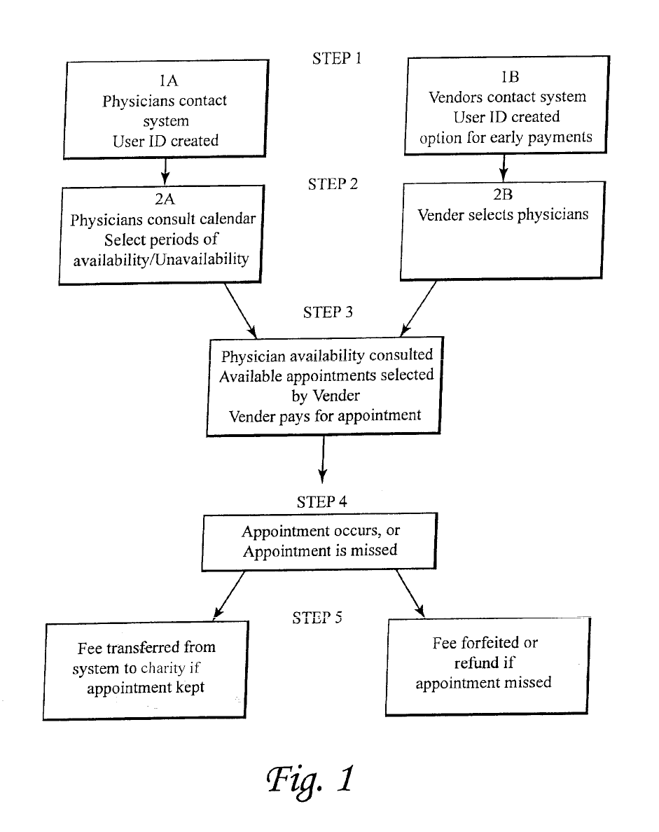

Referring to FIG. 1, the method and system of the present invention is shown and described. Referring to Step 1, of the system, participating physicians 1A and participating vendors 1B enroll in the system. In one preferred embodiment of the invention, the system comprises an Internet based, including web hosted site, where new users can enroll as physicians and venders. Physicians can create a secure user ID, and may include information indicating the types of services they provide, including biographical information. Venders can create a secure user ID, and may include information regarding their products and services. In one preferred embodiment of the invention, venders pay an initial fee for enrollment in the system. In another preferred embodiment, Ds may be PIN number protected.

Referring to Step 2A, once enrolled, physicians may consult their own office calendars, and select the times they will be available for appointments with venders. Once these times are identified, they may input this information into the system, including the webpage of the system, which will maintain a calendar of availability for all participating physicians. In one preferred embodiment, the physician's staff will be able to register periods of unavailability with the system to account for blocks of time wherein the physician is unavailable.

Referring to FIG. 2B, once enrolled, venders may consult the identities and specialization of physicians who, based on their stated areas of expertise, may be interested in the goods and services offered by a vender.

Referring to Step 3, the system posts the availability of participating physicians, including a search feature that allows vendors to seek out physicians according to a variety of parameters. Time periods already selected for appointments are blocked off and invisible to vendors so that only available appointment times are shown.

At this stage, when an available appointment is selected, the vendor is prompted to pay for the appointment. Venders can then check the availability of the physicians in question, and when an appointment is selected, the vendor pays for the appointment. In an alternative embodiment, vendors may maintain accounts in the system that allow them to pay fees in advance, and when appointments are selected, individual charges are made to the vendor account.

Referring to Step 4, the appointment is either kept by the parties, or fails to occur on the account of either the physician or the vendor. In various alternative embodiments, protocols are set up that govern the duration, frequency, and timing of appointments. These embodiments can include: Appointments comprising five minute time periods, wherein multiple consecutive appointments may be allowed or not allowed according to the internal rules of the system, or according to protocols set by individual physicians; appointment frequency rules permitting appointments made up to seventy five days in advance of a scheduled office visit, and only permitting a predetermined number of appointments within a predetermined time, including one appointment every thirty days; a protocol allowing vender representatives to cancel appointments up to a predetermined time prior to the appointment for banking, after which the appointment fee is forfeited, including forty eight hours prior to an appointment; and a protocol governing the grace period after a scheduled appointment beyond which appointment fees will be forfeited, including a five minute grace period; finally, a protocol governing physicians may also be a part of the system. In particular, a rule governing the period of time after an appointment is scheduled, beyond which an appointment is determined to be cancelled, including twenty minutes after the scheduled commencement of an appointment. If the physician does not keep the appointment, the fees do not result in donatable proceeds and are thus banked for the vender representative and maintained within the system.

In one preferred embodiment, the physician's staff will monitor the timing of appointments, and whether appointments are kept or missed, and will report these events to the system. In a further preferred embodiment, venders can enter information regarding representatives and their supervisors into the system, wherein physician staff can access the supervisor of a non-appearing representative after an appointment is missed.

Referring to Step 5A, in a preferred embodiment of the system, proceeds from all of the previous month's successful contacts will be donated to a physician chosen educational or charitable organization according to a donation schedule, including donations made by check within the first 20 days of the new month.

Referring to Step 5B, when appointments that are missed by a vender or physician, the appointment fee will either result in donatable proceeds to a physician chosen educational or charitable organiztion or be refunded to the vendor, including reimbursement to a vendor account within the system, according to the protocols of Step 4. As previously mentioned, the physician's staff may monitor events and register kept and missed appointments and the identity of the responsible party within the system. In a further preferred embodiment, the data gathered during Step 5 may be used by the system to generate reports regarding the total number of missed and kept appointments by both venders and physicians, in order to administer enrollment privileges in the system. The system maintains a calendar that reflects scheduled appointments, weekly or monthly, and a twelve-month running history for each enrolled physician and/or vender representative, including a record of physician donations.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

I claim the following:

1. A system and method of providing access to physicians by medical venders and making donations, comprising the following steps;
a. at least one vender and at least one physician registers with a database for scheduling appointments between the at least one vendor and the at least one physician;
b. the at least one physician, or a physician's representative, enters a calendar of available time segments into the database for meeting with the at least one vender;
c. the at least one vender purchases at least one time segment from the database by paying a fee, said time segment corresponding to an appointment of a specified time with the at least one physician;
wherein, if the appointment is kept by both the physician and the vender, at least some portion of the fee becomes proceeds that are donated to an educational or charitable organization of the physician's choosing; and wherein, if the appointment is not kept, the fee may either be returned to the vendor or at least some portion of the fee become proceeds that are donated to an educational or charitable organization of the physician's choosing.

2. The system and method of claim 1, wherein the at least on physician enters a physician profile, including specialties and practice areas, into the database.

3. The system and method of claim 1, wherein the at least one vender enters a vender profile, including information about the vendor's goods or services, into the database.

4. The system and method of claim 1, wherein if the appointment is not kept by the physician, the fee is returned to the vendor, and wherein if the appointment is not kept by the vendor, the fee becomes proceeds that are donated to an educational or charitable organization of the physician's choosing.

5. The system and method of claim 1, wherein the at least one physician, or a physician's representative, provides a report for entry into the database on whether or an appointment was kept.

6. The system and method of claim 1, wherein the vendor, or a representative of the vendor, provides a report for entry into the database on whether or not an appointment was kept.

7. The system and method of claim 1, wherein protocols determine whether or not an appointment was kept, wherein the protocols include the maximum amount of time allowed prior to an appointment that a physician may cancel an appointment before the fee is refunded to the vender, and the maximum amount of time allowed for a vender to cancel an appointment before the fee is forfeited by the vender.

8. The system and method of claim 1, wherein the at least one physician identifies the at least one educational or charitable organization upon registering with the database to which donations will be made.

9. The system and method of claim 1, wherein the at least one physician designates the at least one educational or charitable organization to which a donation will be made after the at least one physician and the at least one vender completes an appointment, and the at least one physician, or a representative of the physician, reports the identity of said educational or charitable organization to the database.

10. The system and method of claim 1, wherein the at least one vendor pays an administrative fee upon registering with the database.
